(19) United States
(12) Patent Application Publication
(10) Pub. No.: US 2024/0268354 A1
(43) Pub. Date: Aug. 15, 2024

(54) GAIT ASSESSMENT SYSTEMS AND METHODS USING ACOUSTIC DATA

(71) Applicant: Barbara T. PAGE, Littleton, CO (US)

(72) Inventor: Barbara T. PAGE, Littleton, CO (US)

(21) Appl. No.: 18/440,805

(22) Filed: Feb. 13, 2024

Related U.S. Application Data
(60) Provisional application No. 63/445,225, filed on Feb. 13, 2023.

(51) Int. Cl. A01K 29/00; A61D 99/00; G01H 3/12; G10L 25/51

(52) U.S. Cl. CPC A01K 29/005; A61D 99/00; G01H 3/12; G10L 25/51

(57) ABSTRACT

Disclosed herein is a system and method for identifying a gait characteristic of a mammal or other form of animal from an audio signal. The audio signal includes audio portions corresponding to footfalls of the animal. By comparing, for example, the acoustic attributes (e.g., decibel level) of each footfalls, the system may automatically identify abnormal gait characteristics such as one foot landing softer relative to another indicating some possible problem with the foot or leg of the softer landing foot.

### CROSS-REFERENCE TO RELATED APPLICATION

This application is related to and claims priority under 35 U.S.C. § 119(e) from U.S. Patent Application No. 63/445,225, filed Feb. 13, 2023, titled “Gait Assessment System and Methods,” the entire contents of which is incorporated herein by reference for all purposes.

### TECHNICAL FIELD

The present disclosure is directed to a gait assessment system and methods of use thereof. More specifically, the system and method are used to identify gait characteristics from acoustical signals of footfalls.

### BACKGROUND AND INTRODUCTION

Mammals can suffer from issues that present themselves through a gait abnormality. Gait abnormalities occur from sudden injuries, arthritis, chronic over exertion of soft tissue and/or joints, and temporary over training or use, among other things. Such abnormalities may cause alterations in gait, including temporary or permanent loss of form, cause pain and reduced ability for normal function of the musculoskeletal system, decreasing the athletic use, normal day-to-day functions and sometimes the lifespan of the animal or person. As recognized herein and described in greater detail below, objective, repeatable data on the form, load, stride length, and absorption of concussion of each limb of the patient can improve accurate diagnosis of what tissues may be pathologic. This allows treatment for specific tissues whether joint, tendon, ligament, cartilage. Conventional methods, however, for diagnosing such issues include visual observation, digital palpation, history, and for human subjects a discussion of the concerns, which may all be categorized as subjective data. In contrast, objective measurements, particularly for four legged mammals, are currently believed to be primarily limited to force plates, pressure mats and pressure shoes. A known issue that affects the use of such objective systems is that they often change the natural gait of the patient complicating their use, and sometimes disguising, or exacerbating the gait abnormality, among other concerns. Body mounted inertial sensor-based systems are also available, but the use of such systems is cumbersome, relatively complicated, often prohibitively expensive, inconsistent, and do not provide any data related to absorption of concussion.

Unlike a human that can describe the pain and help a doctor isolate the cause of an injury, a horse or other non-human mammal cannot. Besides the various drawbacks of current techniques mentioned above, this makes diagnosis challenging. Moreover, although a human can describe the pain, a placebo effect reported as high as 40% can obscure causes of pain and the like driving a need for objective data to identify clinical or subclinical gait abnormalities. For any of the various reasons introduced here, accurate identification of an injured limb, or other problems manifesting a gait problem, is difficult and often misdiagnosed. For example, about 50% of horse leg injuries are misdiagnosed in some way, often by misidentifying a leg as having a problem when it was in fact a different leg or other problem entirely.

Accordingly, there is a need in the art for a system and method to identify changes in or abnormal gait characteristics that includes an objective aspect, and that is accurate, is consistent, and/or is repeatable. It is also desirable to have a system and method that is convenient to use, and/or is cost-effective.

### SUMMARY

The inventor recognized that acoustical data of the footfalls of mammals carries objective information about the mammal, and that if understood may be used to reveal information about the mammal. With this recognition in mind, among many others, aspects of the present disclosure were conceived.

Aspects of the present disclosure involve obtaining acoustic data from the footfalls of a mammal. The acoustic data may be audio data collected from a microphone or other sensor capable of obtaining such data. In some examples, a single microphone may be used to collect acoustic data from each footfall. Regardless of how the acoustic data is collected, aspects of the present disclosure further involve associating discrete acoustic signals, sometime referred to herein as an audio portion or the like, to a discrete footfall and a specific limb of the mammal. In the case of a human, audio signals of the left foot striking the ground while a person is walking or running may be separately identified from the audio signals of the right foot strike the ground. In the case of a quadruped like a horse, audio signals of the four hoofs and associated limbs may be isolated from one another.

Various attributes of the audio portions may be analyzed alone or in various combinations. Attributes that contain information about the mammal include signal amplitude variations, which may be obtained through decibel levels or other measure of the signal amplitude for an audio portion. Generally speaking, the signal amplitude from a foot strike is used as a measure of the force, or peak force, at which the mammal strikes the ground, which may also be considered support of mass. The measurement may include an average of several amplitude measurements, or other audio techniques of measuring sound level. Information from the signal amplitude may be obtained from detecting a difference in signal amplitude between two limbs. For example, if one limb regularly carries more load than another limb, the difference recognized from one limb impacting the ground with a relatively larger signal amplitude, then the limb carrying less load may be recognized as having some issue, or some other part of the body is having an effect on the limb. In horses or other quadrupeds, this is often referred to lameness in a limb. Besides comparing against another limb (or other limbs), signal amplitude discretely or balance in signal amplitudes may be obtained and considered before and after treatment to assess the efficacy of a treatment, to assess the effect of different shoes or different surfaces on gait, before and after training or therapy discretely or over time to assess the efficacy of the same and even periodically to identify emerging but yet otherwise undetectable problems or the lack of the same.

Another attribute includes timing between footfalls obtained from the acoustic data. By obtaining an acoustic data stream collected with a time attribute such as time, decibel pair from a microphone or however the microphone may capture acoustic data over time, and associated discrete audio portions in the acoustic data with a specific footfall, the system may determine the time of each footfall and derive the timing between footfalls. In the case of a biped, the time is simply between left and right. In case of a quadruped, the system may assess timing between whatever combination of footfalls contains useful information. This information may be assessed alone or in combination with other attributes. Like signal amplitude, timing and stride information may be obtained between or among footfalls, before and after treatment, before and after some intervention like training, surface variations, shoe changes, physical therapy, pharmacologic, surgery or the like.

Another attribute of the acoustic signal that may be obtained and analyzed is the shape and time of each discrete audio portion, considered alone, against a baseline or standard, compared against other discrete audio portions of either the same foot fall or compared to other footfalls of the same mammal. The width of the audio portion may be correlated to the time of a ground impact or the type of ground impact, the number of distinct peaks in a given audio portion may also correlated to different types of footfalls, e.g., toe first versus heel first, an indication of absorption of concussion of movement.

Aspects of the present disclosure include a method of application of acoustical devices, collection of acoustical data from devices, and the interpretation of acoustical data as it related to gait characteristics of a mammal. The audio signal(s) associated with the footfall and/or variation among footfalls, and/or signal comparison between footfalls (e.g., of a human or other biped) or four limbs (e.g., of a horse or other quadruped) in acoustic form, acoustic levels (e.g., decibels), timing of acoustical data associated with such limbs, and characteristics of acoustic data will give objective data to the normal or abnormal functions of any and all various characteristics of gait including footfall type, load, stride length, alterations in stride patterns, and/or absorption of concussion, among others of a human or other mammal.

Aspects of the present disclosure further include a method to identify a gait characteristic from an audio waveform and/or an acoustical difference between a first audio signal portion and a second audio signal portion. The first audio signal portion represents a footfall associated with a first limb of the mammal as the mammal locomotes on a surface and the second audio signal portion represents a footfall associated with a second limb. Based on the acoustical difference, the method can identify the first limb as being favored by the mammal, identify normal or abnormal stride patterns, and other characteristics discussed in further detail herein.

### BRIEF DESCRIPTION OF THE DRAWINGS

FIG. 1 is a block diagram of one possible system to assess a gait characteristic of a mammal according to one example.

FIG. 2 illustrates a system to assess the gait of a mammal according to one embodiment of the present disclosure.

FIG. 3 illustrates a system to assess the gait of a mammal according to one embodiment of the present disclosure.

FIG. 4 illustrates a system to assess the gait of a mammal according to one embodiment of the present disclosure.

FIGS. 5A-5B illustrate a system to assess the gait of a mammal according to one embodiment of the present disclosure.

FIG. 6 is a flow chart of a method for assessing the gait of a mammal according to one embodiment of the present disclosure.

FIGS. 7A, 7B, and 7C illustrate ground strike data, stride timing data and a representative audio signal for a toe strike.

FIGS. 8A, 8B, and 8C illustrate ground strike data, stride timing data and a representative audio signal for a flat-footed landing.

FIG. 9 is a block diagram illustrating an example of a computing system for implementing certain aspects described herein.

### DETAILED DESCRIPTION

Provided herein is a system and method for assessing the bipedal or quadrupedal gait attributes of a mammal, such as a horse (quadruped) or a human (biped). For simplicity, this disclosure is primarily described with regard to use and application of the system to a horse, but the systems and methods discussed herein are applicable to and useful for bipeds such as humans and a variety of quadrupeds such as dogs, cats, and other mammals. Various mammals that may need treatment, like horses, are unable to speak to communicate pain to trainers, riders, or veterinarians, among others, but the horse may manifest lameness in the form of an abnormal or altered gait. Therefore, the system and method disclosed herein can identify a problem in a mammal's gait and/or identify a limb associated with the problem in the mammal's gait, which can be used then to identify the source of the problem such as an existing injury, some form of degenerative problem, or the like and/or predict a future injury (e.g., worsening injury) so that the mammal can be treated. Treatment may range from rest or rehabilitation to some form of drug or surgical intervention.

The assessment includes analyzing an audio waveform of the footfalls recorded as the mammal moves (e.g., walks) along the ground. Although the term “footfall” is used extensively herein, it may also be referred to as a ground impact. In some animals, such as a horse, it is recognized that a hoof may not be considered a foot. Nonetheless, for purposes of this application, the term footfall is meant to encompass when a mammal, whether or not technically having feet such as in the case of a hoof, locomotes on a surface and generates a detectable/recordable audio (acoustical) signal from ground impacts. From the audio waveform, the system may identify and/or assess a host of characteristics of or related to the gait of the mammal. For example, from the decibel level of a specific footfall or from a comparison among decibel levels of footfalls the system may identify and/or assess a support phase or load on a given limb. Relatedly, the system may record the audio signals for footfalls of a mammal walking, and determine that one foot is disproportionately absorbing less concussion than the other feet (and associated limbs). Relatedly and in another example, the system may identify and/or assess, absorption of concussion through a quantification of various attributes, such as the shape, of a portion of the waveform correlated with a footfall. In another example, the system may identify and/or assess the time between various possible combinations of footfalls, which may be used to identify and assess swing phase and stride length. The various possible stride combinations may include right hind (RH) to right front (RF), RF to left hind (LH), LH to left front (LF), LF to RH, RH to LH and RF to LF, any of which alone or in combination may be indicative or otherwise be used to identify a cause or range of possible causes for a gait abnormality. In another example, the system may characterize the type of footfall, e.g., toe first, heel first, or flat footed, by the shape of a signal portion of a given footfall. For example, a toe first landing may have an audio signal portion with distinct peaks at the start and end of the signal portion, and a lesser decibel area between the peaks. In these various example and others discussed herein, besides obtaining and analyzing the audio signals, the system correlates and uses signals that are correlated with audio signals of a particular foot (limb).

The audio waveform may be recorded by one or more microphones, which may be attached to the mammal or otherwise positioned to record the audio waveform while the mammal is moving. In some implementations, a computing system may directly process the audio waveform (or waveforms) to identify some aspect of an abnormal gait, including identifying a limb (or limbs) causing the abnormal gait, and/or characterizing different types of footfalls based on a portion of the audio waveform for a given footfall. In some examples, this disclosure refers to an audio waveform including audio waveform portions for specific footfalls. This refers to a system where one microphone records an audio waveform that includes audio waveform portions for each footfall (two distinct footfalls for a biped and four distinct footfalls for a quadruped). While one microphone may be used, it is possible to also use two or more microphones recording specific footfalls; nonetheless, each footfall is associated with its own audio waveform portion.

In some implementations, the audio waveform may also be displayed alone or in conjunction with a synchronized video file of the moving mammal. Synchronization refers to the video file being displayed in time alignment with the audio waveform so that audio portions for a given footfall are aligned in time, and visually, with the corresponding image of the video file. In some instances, the system captures and processes the audio signal and identifies some gait attribute without displaying the audio waveform and/or without capturing and/or displaying any form of video file.

In various aspects, the portions of the audio waveform corresponding to each respective foot, or hoof, impacting the ground as the mammal walks are identified. In various embodiments, the audio waveform may include an association between a discrete footfall and the audio waveform portion corresponding to that footfall. In some examples, differences in the audio waveform corresponding to footfalls, (e.g., two or more portions of the audio waveform (e.g., corresponding to two or more feet or hoofs impacting the ground)) may be compared to determine if the mammal is favoring one of its legs. So, for example, a mammal favoring one leg, will alter its ground engagement of that leg, which is detectable by an audio signal difference (e.g., a difference in amplitude and/or width of the discrete audio portions for each leg being compared) relative to another leg that is not being favored and/or being used by the mammal to compensate for the lameness. The system, as such, can automatically determine a difference in absorption of concussion.

With the audio and video synchronized, there are various advantages. First, a user may confirm various outputs from the system or may further assess discrete footfalls, gait or the like. In terms of output verification, if the system identifies a toe first footfall for the LF, a user may view the video file to confirm the mammal is landing toe first. Similarly, the system may include a user interface where such a confirmation is noted or, in a situation where the system did not or could not identify the type of footfall, the user may enter or select such a designation after viewing the video, which designation may be used in further analysis, to alter an initial conclusion, or to label data for training a machine learning model.

As noted, the video may be synchronized with the audio waveform, which through comparison of the audio and video files facilitates identification of discrete portions of the audio waveform that correspond to each of the respective footfalls (e.g., foot impacting the ground). Through a user interface displayed by the computing system, a user may view the video file and identify when a particular foot strikes the ground, which identification is associated with the audio waveform so that discrete portions of the audio waveform are associated with a specific foot of the mammal striking the ground. In another alternative, a mobile device such as a tablet, mobile phone or the like, may include an application that receives and records the audio waveform, and displays a graphical user interface whereby a user in the field may mark each time a foot strikes the ground and further identify which foot is striking the ground. Here, the audio signal is marked with LF, RF, etc. (or some other form of designation), so that audio signal portions for each respective footfall are similarly marked.

Aspects of the present disclosure further involve methods by which an audio signal of footfalls may be assessed to identify some gait abnormality including a difference in a particular footfall as compared to others or a baseline, uneven stride lengths, and/or a type of footfall, which may be in turn, alone or in numerous possible combinations directly outputted and/or correlated with possible causes and provided as an output. More particularly, the methods may assess one or more characteristics (e.g., various possible measures of signal amplitude (e.g., peak decibel, average decibel, etc.) of discrete signal portions correlated with a specific footfall, or other attributes of a signal portion including a signal width, signal area, signal position, signal shape). The signal characteristics may be correlated to and use to correspondingly quantify or more generally assess the load on a specific limb (the support phase), which may be further specified to a load of a specific part of a support phase (e.g., toe strike, mid stance, etc.) the stride timing, which may be correlated or include stride length, of a limb in relation to other limbs (the swing phase), and/or absorption of concussion of a limb. Besides identifying various possible characteristics of gait, the system may also use the information to indicate which limb (or part of a limb) is abnormal and possible causes for the same. As one example, the method can assess the load on a limb (e.g., through decibel measurements of the same part of a footfall of respective limbs) to identify a leg that is loading and/or absorbing more or less relative to other limbs. As another example, the method can assess the stride timing, and assess timing differences, and further use that information to identify a leg or legs with differences in the muscle and/or ligament function of the leg(s).

As previously discussed, the system can display the audio waveform (or waveforms) and/or video of the animal as it moves. In some embodiments, the display can be a touch sensitive display (e.g., a touch screen), such that the user can interact with the display. In some embodiments, a mobile device (e.g., mobile phone, tablet) application can employ the internal microphone of the device to record the audio waveform. For example, the mobile device can be held by the human and the microphone can record the sound of the human moving (e.g., walking). In another example, the mobile device can be attached to the body of a human (e.g., attached to the arm, leg, chest or the like wherever the audio signal from each leg is evenly recorded) and the microphone can record the sound of the human moving (e.g., walking). In another example, a remote microphone may be coupled with a mammal (human or otherwise) to record or transmit an audio signal to the mobile device. Processing may occur on the mobile device, or the audio data may be transmitted to a cloud or other server based system to process the data and return results.

In such mobile environments (and otherwise), the application, implementing various methods discussed herein, can analyze the gait of the human, and provide information about the gait and identify possible abnormalities. The system may be used in training feedback where a person may detect gait changes, which may be valuable in preventing injury, optimizing training times and distances, detecting break-down in form, and a host of other possible uses. With a human oriented system or other possible uses, the system may also compare the audio signal to a baseline, which may be of a normal generic gait, of a historical abnormal gait of the subject, and/or a historic normal gait of the subject. In this manner, a human can monitor his or her own gait by using the application on the mobile device. In other examples, a microphone and a receiver can be integrated into any wearable device (or wearable devices), such as a smart device (e.g., smartwatch, smart bracelet, smart glasses, smart ring) or other device that a human athlete can wear during an athletic event. In some examples, both the microphone and receiver can be integrated into one wearable device. For example, a smart watch can include a microphone that records the sound of the human moving and can also include a receiver to receive the waveform. Moreover, the smart watch can display information about the gait of the human. In other examples, the microphone and receiver can be integrated into separate devices.

The system may also be used to assess the effect of some treatment including pharmaceuticals, orthobiologics, physical therapy, recovery from surgical intervention, chiropractic intervention, the effect of shoes, socks, inserts, etc. Such treatment assessments, where appropriate and possible, may be conducted on humans, horses, and other bipeds and quadrupeds. In the particular case of pharmacologic settings, various aspects of the present disclosure may be used to assess efficacy of a product in development, testing, and/or treatment. The effect of a product may be assessed relative to another product, a baseline, over time and treatment to assess improvements in gait, etc.

The system and method for assessing the gait of a mammal may provide significant benefits over conventional gait assessment systems (e.g., force plates, pressure mats, pressure shoes). As one example, the presently disclosed system and method may accurately and consistently assess the gait of a mammal, such as by capturing information about the gait of the mammal without altering the mammal's behavior or environment, resulting in an easier system to use, a more compliant patient, and ultimately more accurate data, which may lead to more accurate diagnosis and assessment more generally. Conventional gait assessment systems, on the other hand, may change the normal gait of the mammal, force the mammal into an unnatural setting, and require awkward connections to the mammal's leg or foot, which alone or in combination can cause inaccurate and/or inconsistent results.

As another example, the presently disclosed system and method may be more convenient to use than conventional gait assessment systems. As one example, the presently disclosed system and method can use a microphone (or microphones) to collect audio signals of the animal walking. This may be more convenient and easier to use, as well as producing better results, than conventional gait assessment systems, which may involve pressure or kinematic wearable sensors.

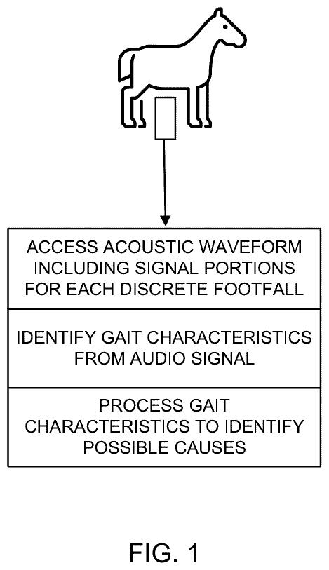

FIGS. 1-5B illustrate an exemplary assessment system 100 for detecting characteristics of the gait of an animal 10 (e.g., a mammal). The system obtains and processes an audio signal including portions associated with discrete footfalls of the subject. As illustrated in FIG. 1, the subject is a horse, but it may be other types of mammals including humans, with reference to a horse herein being used to simply illustrate and discuss various aspects of the disclosure. The audio signal is accessible by a processing unit or units that implement various aspects of the disclosure. Discussed above, the audio signal may be obtained in various ways, e.g., a microphone or microphones mounted to horse, or otherwise, and the processing unit may be a part of a computing device, e.g., a server, laptop, tablet, or smart phone, that accesses the audio signal or otherwise receives and stores the signal for analysis.

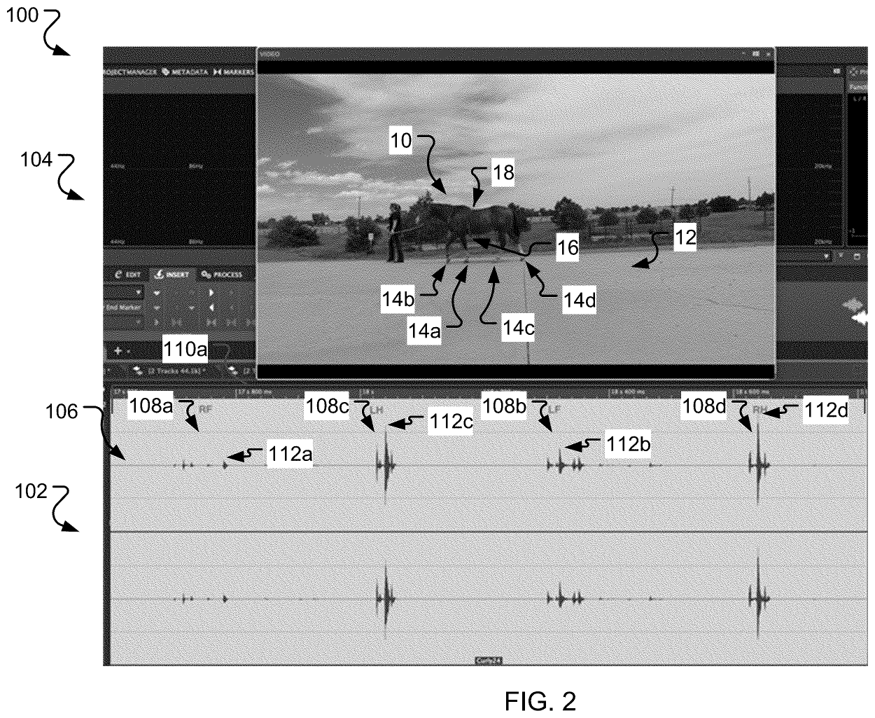

As used herein, the term “gait” refers to the pattern of leg movement of the animal 10 during locomotion across a surface 12. An attribute of gait includes aspects of a discrete footfall or comparative data and assessments of the same (e.g., acoustic decibel levels between front feet indicating one foot/leg being lame relative to the other or generally). The surface 12 can be, for example, dirt, turf, or synthetic. As used herein, the terms “locomotion” or “locomoting” refer to the mammal 10 moving from one place to another, such as by walking, hopping, jumping, or running. In one possible arrangement, to obtain acoustic data for the methods discussed herein, the animal should be guided in a form and rate where each hoof (or foot, etc.) strikes the ground at a distinct time such that distinct audio portions are recorded for each foot impacting the surface, which in the case of a horse occurs typically when a horse is simply walking. Although FIGS. 2-5B are for a horse walking forward, other directions of movement (e.g., lateral movement, rearward movement) are also contemplated, particularly for a human subject.

Referring to FIGS. 2-4 and otherwise, the audio signal 102 includes discrete recorded audio portions 108 (e.g., 108a, 108b, 108c, 108d) (also referred to as audio signal portions) of each respective foot of the animal 10 impacting the surface 12). In addition to the audio signal waveform 102, the assessment system 100 may also include a video display 104 generated from video of the animal 10 locomoting on the surface 12. The audio signal and video are described with additional detail, below.

As introduced above, a biped or quadruped may be the subject of various examples of the present disclosure. With reference to a quadruped, e.g., the horse shown in FIGS. 2-4, there are four limbs 14 (e.g., 14a, 14b, 14c, 14d) with audio signals from the same analyzed. A human subject will have two limbs. Other subjects may have two or four limbs. While not specifically referenced in detail, the system may also be used to analyze and generate information concerning the gait of a subject with a missing limb or an artificial limb.

The system 100 can be used to assess attributes of the gait of the animal 10. The gait of a horse, for example, can include natural gaits (e.g., walk, trot, canter, gallop), ambling gaits, and/or trained gaits. Assessing the gait may include the various assessments mentioned above including differences in footfalls, stride and characterization of footfalls, among other things. To assess the gait of the animal 10, the system 100 receives or otherwise accesses an audio signal 106 that includes discrete audio portions 108 (e.g., 108a, 108b, 108c, 108d), which are each associated with a discrete footfall of each limb 14 (e.g., 14a, 14b, 14c, 14d).

Generally, the system may assess a characteristic (e.g., peak, peaks of discrete portions, width, area, and/or position) of one or more audio portions 108 to generate some characteristic of the gait. The system may compare signal characteristics of the audio portions, compared signal characteristics to a baseline signal or value, compare characteristics to a threshold value, compare to a representative signal portion (e.g., a signal associated with a type of footfall), or compare signal characteristics against other signals associated with other limbs. In these manners, alone or in combination, the system 100 can detect one or more aspects of the gait (normal or abnormal) of the animal 10, such as the functions of each limb 14 (e.g., supporting the weight of the animal, stride timing, and absorption of concussion on impact). Further, various aspects of gait may be indicative of an injury or causal condition affecting gait to the animal 10, which the system may further identify. In such situations, the system may provide areas for a veterinarian, doctor, physical therapist, coach or other professional to assess or confirm. Although an injury or condition of a subject may be directly related to a gait abnormality (e.g., joint injury (e.g., arthritis), tendon injury, ligament injury), in some instances the injury or condition may not be directly related to any particular limb 14 such as in the case of a spinal or more generally back problem.

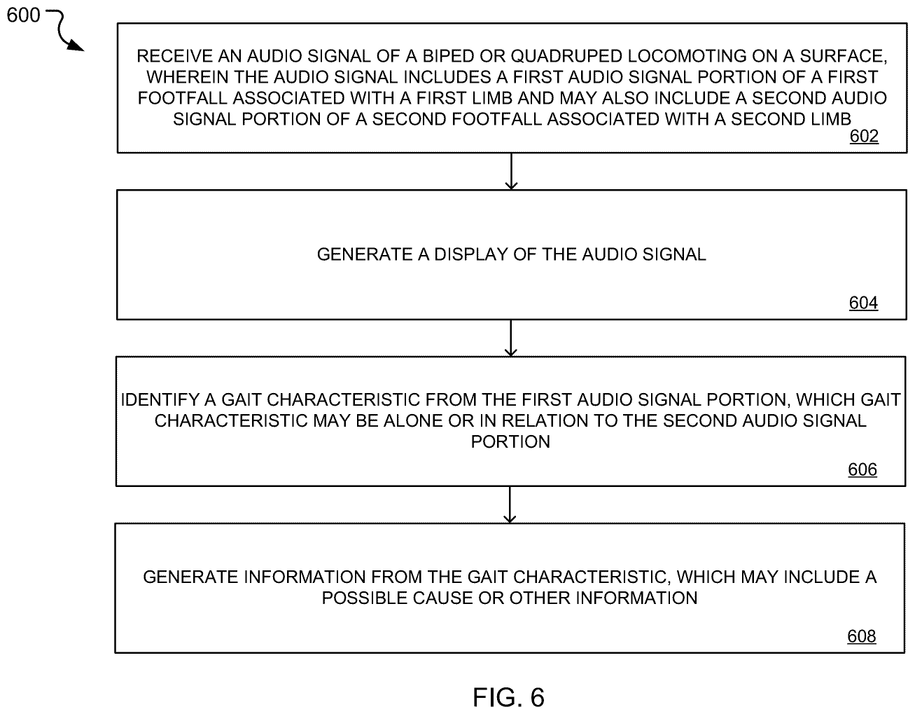

Referring to FIG. 6, a flowchart is presented in accordance with one example embodiment. The method 600 is provided by way of example, as there are a variety of ways to carry out various operations and combinations of operations discussed herein. The method 600 described below can be carried out using the configurations illustrated in FIGS. 2-5B, for example, and various elements of these figures are referenced in explaining example method 600. Each block shown in FIG. 6 represents one or more processes, methods, or subroutines, carried out in the example method 600. Furthermore, the illustrated order of blocks is illustrative only and the order of blocks can change according to the present disclosure. Additional blocks may be added or fewer blocks may be utilized without departing from this disclosure.

As illustrated in operation 602 in FIG. 6, the system 100 receives or otherwise accesses an audio signal 106 of the animal 10 locomoting on the surface 12. As discussed, the audio signal may include discrete audio portions 108 (e.g., 108a, 108b, 108c, 108d) corresponding to discrete footfall of the subject. In some aspects, a microphone 16 can record the audio signal 106, as discussed below. Then, the audio signal 106 can be uploaded to memory of a computing platform for further analysis according to the present disclosure. The computing system may include the microhone or may obtain access to the audio signal in any number of ways including over a wired or wireless channel, by way of file transfer, access to cloud storage including the audio signal, etc.

With specific reference to the horse example discussed herein and the examples set out in FIGS. 2-5, the audio signal 106 can include a first audio portion 108a of a footfall associated with a first limb 14a) (e.g., RF) of the animal 10 and a second audio portion 108b of a footfall associated with a second limb 1414b (e.g., LF) of the animal 10. The audio signal 106 can also include a third audio portion 108c of a footfall associated with a third limb 14c (e.g., LH) of the animal 10 and a fourth audio portion 108108d of a footfall associated with a fourth limb 1414d (e.g., RH) of the animal 10.

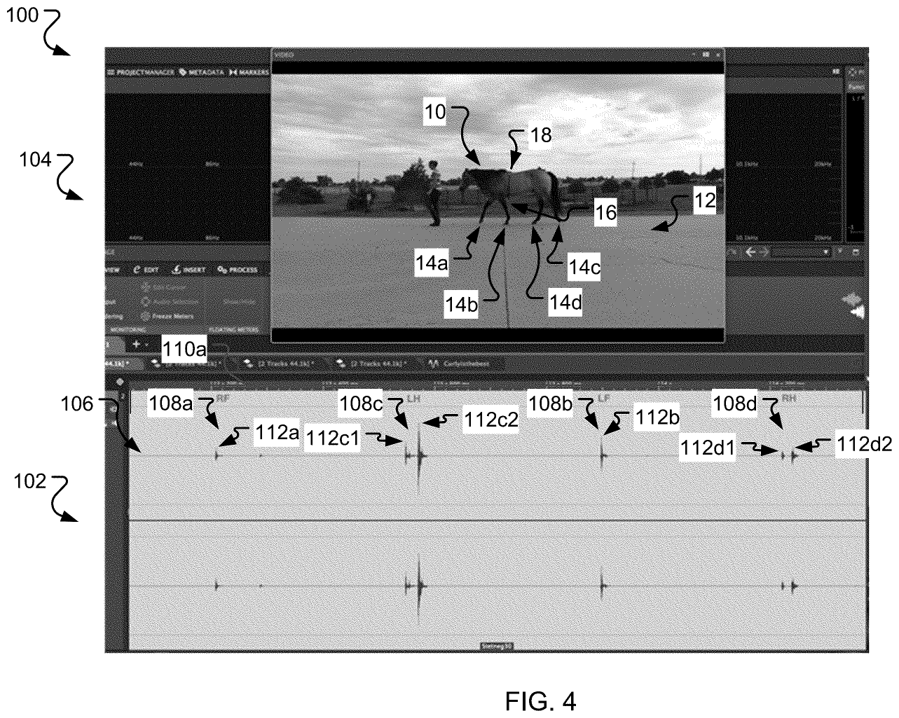

In the illustrated sequence of FIG. 4, as the horse moves along the surface 12, a first foot (here, the RF hoof) associated with the first limb 14a impacts the surface 12 (e.g., first footfall), then a second foot (here, the LH hoof) associated with the second limb 14b impacts the surface 12 (e.g., second footfall), then a third foot (here, the LF hoof) associated with the third limb 14c impacts the surface 12 (e.g., third footfall), and then, the sequence is complete when a fourth foot (here, the RH hoof) associated with the fourth limb 14d impacts the surface 12 (e.g., fourth footfall). The sound of the horse moving is recorded, which in the case of a single microphone results in an audio signal 106 with discrete areas of sound recording based on each discrete footfall. As such, the audio signal 106 includes a first audio portion 108a corresponding to the footfall associated with the first limb 14a (a first footfall), a second audio portion 108b corresponding to a footfall associated with the second limb 14b (a second footfall), a third audio portion 108c corresponding to a footfall associated with the third limb 14c (a third footfall), and a fourth audio portion 108d corresponding to the footfall associated with the fourth limb 14d (a fourth footfall) with gaps where there is little or no audio signal between the audio portions 108.

It should be noted here that the first limb 14a can refer to either the right-front leg, left-front leg, left-hind leg, or the right-hind leg of the four-legged animal 10, while the second limb 14b can refer to a leg on the opposite side (from the first limb 14a) of a sagittal plane of the four-legged animal 10. The third limb 14c and fourth limb 14d can refer to legs on the opposite side of a coronal plane of the four-legged animal 10 from the first limb 14a and the second limb 14b, respectively. As illustrated in FIGS. 2-4, the first limb 14a refers to the right-front (RF) limb, the second limb 14b refers to the left-front (LF) limb, the third limb 14c refers to the left-hind (LH) limb, and the fourth limb 14d refers to the right-hind (RH) limb. However, these references are for illustrative purposes only.

In some embodiments, a microphone 16 collects sound as the animal 10 locomotes on the surface 12 and converts the sound into an audio signal 106. The audio signal 106 is recorded in some storage medium operably coupled with the microphone 16. Alternatively, the microphone 16 may transmit the audio signal 106 for recording at some other device. The recorded signal 106 may then be accessed by a device, such as a computing device that is configured to analyze the audio signal(s) as discussed herein. To isolate the portions of the audio signal associated with a footfall, the system may filter the signal to eliminate noise and other unrelated signal characteristics. In some examples, the microphone 16 is attached to the animal 10 to capture the audio signal 106, which includes audio portions 108 of two or more footfalls, as the animal locomotes. For example, as illustrated in FIGS. 2-5B, the microphone 16 can be attached to a surcingle 18 that is attached to a horse). In at least one example, the microphone 16 can be attached to a ventral portion (e.g., underneath the belly of the animal 10) of the surcingle 18. Placed in this position on a horse, the microphone is able to detect each footfall of the horse. In other examples, the microphone 16 can be positioned at any location on the body of the animal 10 such that it captures the audio signal 106. For example, the microphone 16 can be positioned on the ankle, leg, back, or any other position on the animal 10.

In other examples, a first microphone can record the sound of the footfalls of the front-limbs 14a, 14b and a second microphone can record the sound of the footfalls of the rear limbs 14c, 14d. In other examples, a discrete microphone may be attached to each limb, preferably in a similar location on each limb, and record the sound of a footfall of a respective limb 14a, 14b, 14c, 14d (e.g., a first microphone records the sound of the footfall of the first limb 14a). In such an example, the microphones may be calibrated or otherwise known to produce substantially similar audio recordings so that the signals from each microphone may be compared such that differences in recording are not the cause of differences in signal output. In other examples, the system may use a remote microphone, such as a directional microphone, operated by a human operator that would orient the microphone to collect an audio signal from the horse's feet as it walks. Any microphone arrangement is possible so long as it is capable of recording discrete footfalls with sufficient signal integrity to discriminate between the footfalls, and the signal is strong enough that background noise and the like does not obscure the audio signature of each footfall.

As illustrated in operation 604 in FIG. 6, the system 100 may generate a display of the audio signal 106. In some embodiments, each discrete audio portion 108 (e.g., 108a, 108b, 108c, 108d) can be correlated to each discrete footfall (e.g., limb 14 of the animal 10 impacting the surface 12). For example, the computing system can include a label to identify each discrete audio portion 108 with the corresponding limb 14 (e.g., right-front, left-front, right-hind, left-hind) of the footfall. In some examples, the system 100 can display the audio signal 106 with a label near each audio portion 108 to indicate the corresponding limb 14. In some embodiments, the information correlating each audio portion 108 to each footfall can be embedded in the recording (e.g., the audio file).

In some aspects, a user can mark (e.g., through a user interface) during real time (e.g., during the recording of the animal 10 moving along the surface) when one or more specific feet impact the ground such that each discrete audio portion 108 can be correlated to each footfall, as previously discussed. In some aspects, as discussed below, a video of the animal 10 moving on the surface 12 can be recorded and synchronized with the audio such that the video signal corresponds to the audio signal 106. Then, a user can view the video and mark (e.g., through a user interface) which audio portion 108 corresponds to which footfall. For example, the video can be displayed on the video display 104 (as discussed below) and synchronized with the audio signal 106.

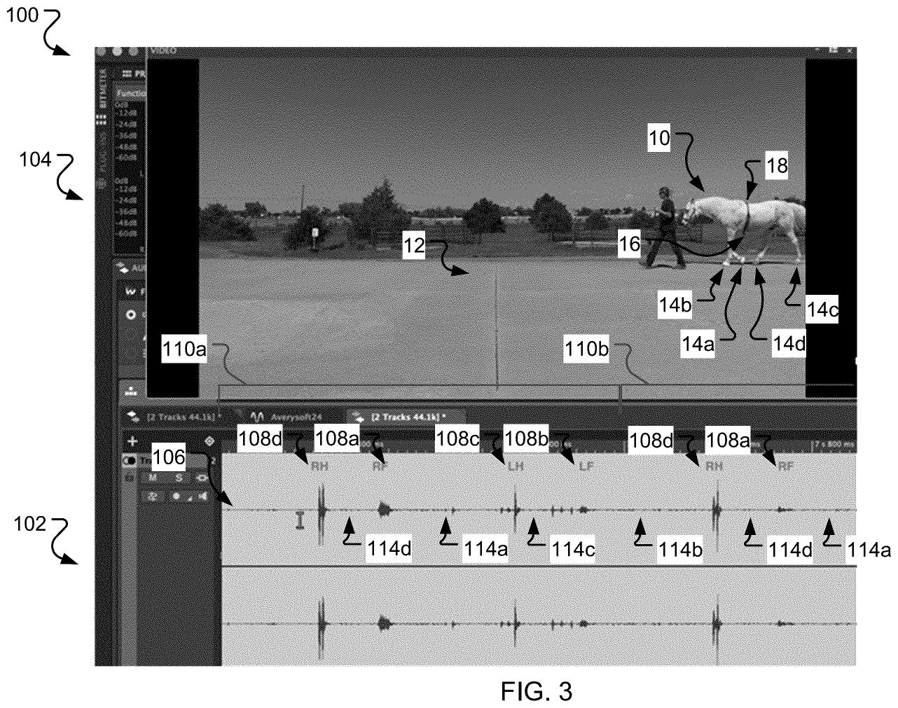

In some embodiments, the audio signal 102 can display one or more cycles 110 (e.g., 110a and 110b of FIG. 3). Each cycle 110 includes one footfall for each respective limb 14 of the animal 10 (e.g., a full pattern of the audio signal 106). In other words, each cycle 110 includes one audio portion 108 for each limb 14 of the animal 10 impacting the surface 12. In some embodiments, the system 100 needs at least one cycle 110 to assess a given footfall alone or in comparison to other footfalls, although additional cycles 110 may be preferred to obtain sufficient samples to identify differences that may be subtle and/or generate averages and compare against averages. As illustrated in FIGS. 2 and 4, a single cycle 110a (e.g., a first cycle) is illustrated that includes the four audio portions 108 (e.g., 108a, 108b, 108c, 108d)). FIG. 3, in contrast, shows one full cycle 110a (e.g., a first cycle) and part of a second cycle 110b). The recorded audio signal may include additional cycles not illustrated.

It should be noted that the sequence (e.g., order) of the audio portions 108 corresponds to the sequence of the gait of the animal 10 (e.g., order of the footfalls). For example, in FIGS. 2-4B the animal 10 is a horse that is walking such that its gait includes the following sequence: right-front (e.g., first limb 14a), left-hind (e.g., third limb 14c), left-front (e.g., second limb 14b), and right-hind (e.g., fourth limb 14d). Notably, when a horse is led at a walking pace, each hoof may strike the ground at a unique time and may also be in a consistent pattern. As a result, as illustrated in FIGS. 2-3, the distinct audio portions are separate in time such that the first audio portion 108a, the second audio portion 108b, the third audio portion 108c, and the fourth audio portion 108d are separated by low or no decibel portion of the audio signal.

As illustrated in operation 606 in FIG. 6, the system 100 may identify a gait characteristic from the audio portion. In one possible example, a gait characteristic may involve comparing audio portions of different footfalls of the same subject to identify an acoustical difference. In one example, a signal amplitude (e.g., decibel level or amplitude or other) of different footfalls may be compared. In the example of the RF and LF footfalls of a horse, a normal gait would be accompanied by the same signal amplitude indicating that the horse is distributing force equally between its front two legs. The system may determine that the signal amplitudes are the same or it may identify a difference in the audio signal portions, e.g., a difference in decibel levels, indicating the horse is landing on one hoof relatively harder (higher decibel level) than the other hoof (lower decibel level). Stated differently, one hoof is absorbing more concussion associated with a louder signal portion than the other foot. This, alone or in combination with other gait characteristics, may indicate a problem in the leg the horse is favoring—the foot/leg associated with a lower decibel level signal.

In the above example, the gait characteristic is from an acoustical difference between a first audio portion relative to one limb (e.g., RF) and a second audio portion of a different limb (e.g., LF). Besides the signal amplitude, the acoustical difference can include one or more differences in the audio portions or more generally distinct audio portion qualities (e.g., signal peak decibel level, width (time) of the audio portion, area under the audio portion, or relative relationship in time) and/or differences in the time interval 114 (e.g., 114a, 114b, 114c, 114d) between the audio portions.

As discussed in further detail below, the audio portion shape may be indicative of a type of footfall. Keeping with the example of a horse, a toe first landing is reflected in an audio signal with two peaks and the initial first peak being greater than the second peak, a flat footed landing being reflected in an audio signal portion with a single peak, and a heel first landing is reflected in an audio signal with two peaks and the second, trailing peak, being greater than the initial peak—e.g., effectively opposite the signal for toe first landing. The system may automatically identify the type of foot landing based on these signal characteristics through comparison to representative signals, identify the number of peaks and relative amplitude of each, and other means. Thus, besides signal differences, the system may identify a gait characteristic from the shape of the signal.

In addition to comparing between audio portions of different footfalls from the same subject, in some examples the system may identify a gait characteristic from a baseline audio portion either of the same subject or other subjects. Discussed herein, the system may include one or more baseline signals from a subject with a normal gait, baseline signals of various characteristics (e.g., toe first, etc.), baselines signals associated with specific ailments—ligament tears, muscle injuries, etc.—and the collected audio signal of a subject and/or discrete audio signal portions associated with specific footfalls compared to such a baseline, with the comparison identifying some gait characteristics depending on the compared baseline, etc.

Further elaborating on identifying a gait characteristic from comparison to a baseline, one or more audio portion (or portions) 108 of the animal 10 can be compared to one or more baseline audio portion (or portions). In some aspects, the baseline audio portion can be an audio portion of one or more baseline animals (e.g., one or more animals of the same species as the animal 10 being assessed). The baseline may also be from the same animal being assessed, where comparison to the baseline may be helpful in understanding if a treatment protocol is improving gait or the like. In such an example, a baseline may be established prior to treatment, and then an audio signal after treatment compared to the baseline to generate comparative data. The baseline audio portion can include baseline characteristics (e.g., peak, width, area, or position). In some examples, one or more of the baseline characteristics can be obtained from an audio portion of one baseline animal. In some examples, one or more of the baseline characteristics can be obtained from an average of audio portions of more than one baseline animal. The acoustical difference can include a difference in one or more characteristics between one or more audio portions 108 of the animal 10 and the corresponding audio portion (or portions) of the one or more baseline animals. For example, a first audio portion 108a associated with a first limb 14a of the animal 10 can be compared to a baseline audio portion (e.g., associated with a corresponding limb of the baseline animal or baseline animals) to identify an acoustical difference.

In some aspects, the computing system can compare corresponding values (e.g., peak, width, area, or position) of two audio portions 108. If the values are the same, the computing system can output that there is not an acoustical difference between those corresponding values. If the values are different, the computing system can output that there is an acoustical difference. In some aspects, the computing system can output the difference between the values.

In some aspects, the computing system can calculate a value (e.g., percentage value, percentage difference value, and/or percentage change value) by comparing corresponding values of two audio portions 108. Based on the calculated value, the computer system can output whether or not there is an acoustical difference in the audio portions 108. For example, the computing system can calculate a percentage difference value between corresponding values (e.g., peak) of the audio portions 108. In some examples, the computing system can compare the percentage difference value to a threshold value. Then, if the percentage difference value is greater than the threshold value, the computing system can output that there is an acoustical difference. If the percentage difference value is less than a threshold value, the computing system can output that there is not an acoustical difference. In some aspects, if the computing system identifies an acoustical difference, then the computing system can output the percentage difference value and/or the associated characteristics (e.g., peak of the right-hind leg is less than the peak of the left-hind leg by 15%).

The assessment of the gait of the animal 10 provides objective and/or numerical data about different functions of one or more limbs 14. Such functions can include supporting the weight of the animal 10, footfall form, stride length, and/or absorption of concussion on impact, as discussed in detail throughout.

As illustrated in operation 608 in FIG. 6, based on any gait characteristic, alone or in various possible combinations, the system 100 can be used to identify if the animal 10 is favoring one of its limbs 14 (e.g., 14a, 14b, 14c, 14d) or otherwise walking abnormally (e.g., a limb 14 is lame), and more generally identify possible causes. In other words, in the example of acoustical differences (e.g., difference in peak, width, area, or position) between audio portions 108 (otherwise referred to as audio signal portion) and/or an acoustical difference between an audio portion 108 and a baseline audio portion can indicate that the animal 10 is favoring a limb 14 (e.g., 14a, 14b, 14c, 14d), which may indicate that the limb 14 is lame.

In some embodiments, the computing system can access a library (e.g., a table) that correlates an acoustical difference between audio portions 108 and/or an acoustical difference between an audio portion 108 and a baseline audio portion with a potential issue (e.g., injury) to the animal 10. In some embodiments, the computing system can identify an acoustical difference, access the library to determine the potential issue, and then output (e.g., display) the potential issue to the user. For example, the computing system can output which limb is experiencing pain, being favored, or otherwise abnormal. In some examples, the computing system can correlate an acoustical difference to a specific ailment (e.g., joint pain, soft tissue pain, muscle weakness) and, in some cases, can output the specific ailment to alert the user.

In another example, the system may include a look-up table with various possible inputs (e.g., gait characteristics) and one or more possible diagnosis based on the inputs. For example, the system may automatically identify a horse with three limbs landing flat footed, one limb landing toe first, some difference in the amplitude of the audio portions between the limbs, and one more stride differences (discussed in more detail below). The system then may process these gait characteristics as entries in a look-up table with one or more possible causes listed that include the combination of gait characteristics or some subset of characteristics. The look-up table may be extensible so that as additional gait characteristics and/or relationships to causes are learned, the table may be updated. Such possible causes are not meant to replace a proper assessment of a subject but, particularly in the case of various animals that cannot directly communicate, may help a professional properly identify a host of difficult to identify gait characteristics and be apprised of possible causes of any abnormalities, which can then be further investigated.

To further illustrate various concepts and systems/methods discussed herein and in one example, audio signal differences associated with lameness of a horse are most noticeable when comparing the audio portions 108 of the two front legs or comparing the audio portions 108 of the two rear legs. It has been observed that the discrete audio portions of a horse that is not lame have substantial similarity between the audio portions 108 of the two front legs and substantial similarity between the audio portions 108 of the two rear legs but not necessarily similarity when comparing front to rear. This may be due, in part, to a horse tending to load its front two legs some percentage more than its two rear legs.

For example, lameness for a particular limb 14 (e.g., 14a, 14b, 14c, 14d) of a horse is presented by its audio portion 108 having a feature that is distinct from the opposing leg or the other legs more generally. For a horse, an acoustical difference between a first audio portion 108a of a footfall associated with a first limb 14a and a second audio portion 108b of a footfall associated with a second limb 14b can be identified (e.g., by comparing the first audio portion 108a to the second audio portion 108b). In one example, the right-front leg (e.g., first limb 14a) can be compared to the left-front leg (e.g., second limb 14b) by comparing the respective audio portions 108a, 108b of the two limbs 14a, 14b. In another example, the left-hind leg (e.g., third limb 14c) can be compared to the right-hind leg (e.g., fourth limb 14d) by comparing the respective audio portions 108c, 108d of the two limbs 14c, 14d.

Various conditions of the horse can cause a difference in audio portions 108. For example, when the horse is not applying its full weight to the limb 14 (e.g., tender hoof, joint pain, arthritis pain), the peak value 112 of the audio portion 108 associated with the affected limb 14 will be less as compared to either the peak value 112 of the audio portion 108 associated with the opposing healthy limb 14 or the peak value of the baseline audio portion corresponding to the affected limb. Similarly, when the horse is applying more weight to an opposing leg, the peak value 112 of the audio portion 108 associated with the limb 14 will be greater. Referring to the notion of the system using a look-up table, here the system identifies the acoustical difference, which may be presented via display or otherwise, between the RF and LF decibel levels, and then inputs those values to a look-up table. Since the signals are different (along with, for example, an amplitude of such difference), the look-up table may include hoof, joint, and arthritis as an output based on a amplitude difference between LF and RF. From this, a professional may conduct further tests to assess the exact cause, but objectively knowing that one limb is being favored.

In another example, if a horse or other quadruped is dragging its hoof, the width of the audio portion 108 associated with the affected limb 14 may be greater (and the peak value 112 may be less) than either the width of the audio portion 108 associated with the opposing limb 14 or the width of the baseline audio portion corresponding to the affected limb. In another example, the horse may be lifting one foot more quickly than the rest of its feet, which can cause the width of that audio portion 108 to be less than the rest. As discussed above, in some embodiments an audio portion 108 can be compared to a baseline value and/or threshold value to determine a condition of the horse. In other words, a characteristic (e.g., peak value, width, area, or position) of the portion 108 can compared relative to a baseline value and/or threshold value to determine if the horse has an abnormal gait as described herein.

The disclosure moves now to specific examples of assessing gait characteristics of an animal 10 with reference to the various figures. As previously discussed, the system 100 can detect one or more characteristics of the gait of the animal 10, such as, for example the functions of each limb 14 (e.g., supporting the weight of the animal, stride length, and absorption of concussion on impact). In some embodiments, the computing system can assess one or more characteristics of the audio signal 106 and/or audio portion 108 (or audio portions) and, correspondingly, determine which limb 14 (or portion of a limb 14) is abnormal.

The ability of the animal 10 to load a limb 14 can be assessed, as illustrated for example in FIG. 2. During the loading of a limb 14 (also referred to as the load phase), the firm tissues (e.g., bone) of the animal 10 support the mass (e.g., weight) of the animal 10. In some examples, assessing the load on a limb can identify and/or confirm which limb 14 is painful (e.g., from arthritis pain, joint pain, or otherwise). For example, when an animal 10 is experiencing pain in a limb 14 (e.g., joint pain), the animal may load the painful limb 14 (e.g., unhealthy) less than the opposite (e.g., healthy) limb 14.

In a horse, for example, the load on a limb can be assessed by comparing a decibel or more generally amplitude value of the audio portion of the right-front limb to a corresponding value of the audio portion of the left-front limb. If the system is using a peak value, or an average value, or an average of peak values of several signals, or an average of midstance values, etc., the same type of value should be used so that like values are compared. In a human or other biped, similar loading comparisons may be made.

A load difference may indicate that the subject is experiencing pain in the limb or there is some cause of such loading difference. In various examples discussed herein including FIGS. 2-4, the load on a limb can be quantified by the decibel level of some part, such as the midstance, of the audio signal portion for the respective limbs.

As illustrated in FIG. 2, the peak value 112b of the audio portion 108b (which represents a footfall of the left-front limb 14b) is greater than the peak value 112a of the audio portion 108a (which represents a footfall of the right-front limb 14a). This means that the horse loads its left-front limb more than its right-front limb, which can indicate that the horse is experiencing pain in its right-front limb (e.g., the less loaded limb). Additionally, the peak value 112d of the audio portion 108d (which represents a footfall of the right-hind limb 14d) is greater than the peak value 112c of the audio portion 108c (which represents a footfall of the left-hind limb 14c). This means that the horse loads its right-hind limb more than its left-hind limb, which can indicate that the horse is experiencing pain in in its left-hind limb (e.g., the less loaded limb).

In FIG. 2, the relative difference between the peak values 112b, 112a (associated with the front limbs 14b, 14a) is larger than the relative difference between the peak values 112d, 112c (associated with the rear limbs 14d, 14c). In this example, the system may identify a peak value of each of the respective audio portions, and provide such values as an output—which may be included in a display of the values. The system may also generate averages of such peak values, e.g., an average of a series of LF peak values, an average of a series of RF peak values, etc.—and generate outputs based on such averages.

In some instances, the system may generate stride length gait characteristics from the audio waveform, as illustrated for example in FIG. 3. It has been observed that the stride length (also referred to as the swing phase) can identify and/or confirm which limb 14 has pain (e.g., soft tissue pain) and/or weakness (e.g., muscle weakness). In a horse or other quadruped, for example, the stride length can be assessed by comparing the time intervals 114 (e.g., 114a, 114b, 114c, 114d) between the footfalls of various limbs 14 (e.g., 14a, 14b, 14c, 14d), as discussed below. In a human or other biped, the stride length can be assessed by comparing the time interval between a footfall of the left limb 14 and a footfall of the right limb (e.g., the time interval between the audio portion of the left limb and the audio portion of the right limb) and/or between successive footfalls of each limb.

In some examples, the stride is assessed through time between footfalls of some combination of limbs (e.g., time between a footfall of the fourth limb 14d and a footfall of the first limb 14a). In some instances, herein, the stride length is referenced; however, in various aspects stride length is assessed through timing comparisons based on time between audio signal portions for some combination of footfalls. For example, time period 114d is the time between audio portion 108d (representing a footfall of the fourth limb 14d) and the audio portion 108a (representing a footfall of the first limb 14a). More generally, the system may compare stride timing between LF-LH and RF-LH, or LF-RH and RF-LH, or other combinations. In some aspects, a stride length can be quantified by the time between the foot landing of the following limbs: right-hind (RH) to right-front (RF), RF to left-hind (LH), LH to left-front (LF), and/or LF to RH. As an example, the time interval 114d can indicate the stride length between audio portion 108d (representing the footfall of the RH limb 14d) and audio portion 108a (representing the footfall of the RF limb 14a). As another example, the time interval 114a can indicate the stride length between audio portion 108a (representing the footfall of the RF limb 14a) and audio portion 108c (representing the footfall of the LH limb 14c). As another example, the time interval 114c can indicate the stride length between audio portion 108c (representing the footfall of the LH limb 14c) and audio portion 108b (representing the footfall of the LF limb 14b). As another example, the time interval 114b can indicate the stride length between audio portion 108b (representing the footfall of the LF limb 14b) and audio portion 108d (representing the footfall of the RH limb 14d). In some embodiments, the computing system can assess one or more time intervals 114, which indicate stride length, and determine which limb 14 is different in the muscle function and/or ligament function.

As illustrated in FIG. 3, the stride length between successive footfalls varies, which indicates that the corresponding stride length varies. Specifically, the stride length from RH to RF and from LH to LF is shorter, which can indicate a decreased ability for the RH limb and LH limb to propel (e.g., push) the body of the animal 10 forward. In turn, this lesser impulsion can indicate a problem in the soft tissue (e.g., muscle, ligament, tendons) of the hind limbs (i.e., the RH and LH limbs).

In other examples, the stride length is the time between corresponding footfalls of the two front limbs (e.g., 14a, 14b) or the two rear limbs (e.g., 14c, 14d). In other words, the stride length can be assessed by identifying the sum of two time intervals 114 (e.g., 114a, 114b, 114c, 114d) between audio waveforms 108 (e.g., 108a, 108b, 108c, 108d). In some aspects, based on one possible gait sequence of a horse or other quadraped, a stride length can be quantified by the time between the foot landing of the following limbs: right-hind (RH) to (LH) and/or right-front (RF) to left-front (LF). As an example, the combination of time interval 114d and time interval 114a can indicate the stride length between audio portion 108d (representing the footfall of the right-hind limb 14d) and audio portion 108c (representing the footfall of the left-hind limb 14c). As another example, the combination of time interval 114a and time interval 114c can indicate the stride length between audio portion 108a (representing the footfall of the right-front limb 14a) and audio portion 108b (representing the footfall of the left-front limb 14d). In some embodiments, the computing system can assess one or more sums of time intervals 114, which indicate stride length, and determine which limb 14 is different in the muscle function and/or ligament function.

The ability of animal 10 to absorb concussion can be assessed, as illustrated for example in FIG. 4. Absorption of concussion mitigates the forces between the load and the ground reaction forces when a limb 14 is loaded. For example, tissues (e.g., cartilage) in the animal 10 can absorb concussion, which can reduce the load on the supporting tissues (e.g., bones). In some examples, assessing the absorption of concussion can indicate if the limb 14 is absorbing concussion (e.g., using absorptive tissues). If a limb 14 is not properly absorbing concussion, the animal 10 may be experiencing pain in that limb 14, such that the pain is hindering absorption of concussion. Due to improper absorption of concussion, pathology such as stress fractures can occur. In some examples, assessing absorption of concussion can identify and/or confirm an abnormal form of load (e.g., excessive strain on tissues not designed for shock absorption). If a limb 14 is properly absorbing concussion, the load on the supporting tissues (e.g., bones) can be reduced. The absorption of concussion can be demonstrated by the initial ground contact of a limb 14 (e.g., 14a, 14b, 14c, 14d) of the animal 10. In some aspects, the system may employ a Teager-Kaiser energy operator to assess the audio signal 106 (e.g., shape of the audio signal 106) and derive concussion absorption characteristics.

As illustrated in FIG. 4, the system may assess the landing of one or more footfalls of the animal 10, to characterize the type of footfall (e.g., heel-first, flat-footed, toe-first, sideways with a twist), which can be valuable alone as well as an input to subsequent system operations to identify some abnormality such as whether the respective limb 14 is facilitating or impeding proper shock absorption. In some examples discussed herein, the system may identify peaks of an audio portion as part of characterizing a footfall. In the examples of a horse, a signal may have one peak value 112 or two peak values 112 during the loading phase of the associated limb. The peak values of a given signal, in the case of two peak values, may also be relatively different. For example, an audio portion 108 having one peak can indicate that the foot of the associated limb 14 is impacting the surface 12 flat footed. When landing flat footed, the load is distributed across a larger surface area as compared to a toe or heel first landing, and hence the relative amplitude of the peak as compared to other types of footfalls may be less. This information may also be assessed by the system and provide an input. As another example, an audio portion 108 having two peaks can indicate that the foot of the associated limb 14 is impacting the surface 12 heel first or toe first, with a relatively large initial peak for a toe first landing and a relatively larger second peak for a heel first landing.

In some examples, a flat-footed landing can indicate excessive pressure on the ball (e.g., bone) of the foot, which can result in decreased blood flow to the foot over time. For example, a flat-footed landing of a horse can lead to a decrease in blood flow to the foot, decrease in growth of the hoof capsule, increase in arthritis in the lower joints and/or shoulder muscles, increased fatigue during athletic events, or a combination thereof. On the other hand, a toe first landing of a horse can cause the horse to stumble and trip. By automatically identifying these gait characteristics, the system may provide helpful insights to a professional for treating, training, resting or otherwise working with an animal to prevent issues.

Inn FIG. 4, both the audio portion 108c (which represents a footfall of the left-hind limb 14c) and the audio portion 108d (which represents a footfall of the right-hind limb 14d) have two peaks. For each audio portion 108c, 108d, the first peak 112c1, 112d1 occurs when the heel strikes the surface 12 (e.g., ground) and the second peak 112c2, 112d2 occurs when the midstance occurs and the rest of the foot comes in contact with the ground. These are examples of heel-first landings, which are typically desirable for the footfalls of a horse. For example, heel-first landings are understood to promote proper shock absorption of the respective limb 14.

Both the audio portion 108a (which represents a footfall of the right-front limb 14a) and the audio portion 108b (which represents a footfall of the left-front limb 14b) have only one peak value 112 (e.g., 112a, 112b) (referred to as one peak). This indicates that the animal 10 is landing flat-footed on these respective limbs 14a, 14b, which can indicate an issue with the respective limb 14. For example, a flat-footed landing can impede proper shock absorption of the respective limb 14. In some cases, a flat-footed landing indicates that the hoof of the horse was incorrectly trimmed.

In some embodiments, the system 100 can identify acoustical differences between two or more audio portions 108 (e.g., 108a, 108b, 108c, 108d). For example, the system 100 can directly process the audio signal 106 and compare characteristics (e.g., peak, width, area, and/or position) between two or more audio portions 108. In comparing the audio portions 108, the system 100 can identify any acoustical differences (e.g., different peak, different width, different area, different position) between the audio portions 108. In some embodiments, the system 100 can display the acoustical differences and/or an output (e.g., that the animal 10 is favoring a limb 14). For example, the system 100 can display a graphical representation, numerical representation, visual indicator, or the like to indicate the one or acoustical differences between two or more audio portions 108. Additionally, in some examples, the system 100 can produce an output (e.g., that the animal 10 is favoring a limb), based on assessment of the acoustical differences. In some instances, the system 100 can display the output, such as with text displaying on a user interface, to alert the user. In this manner, the system 100 can automatically assess the gait of the animal 10.

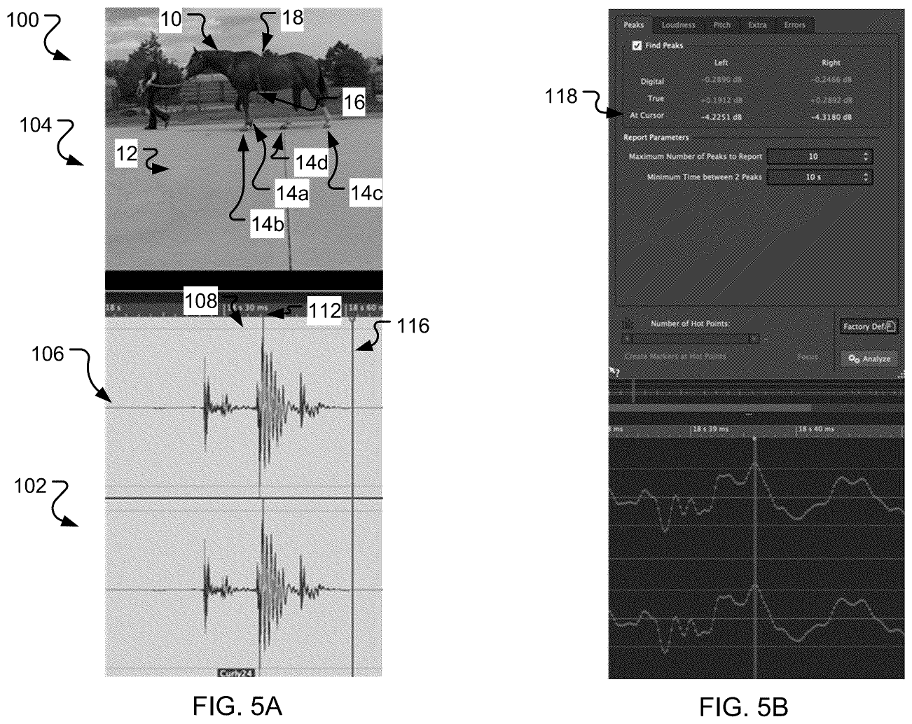

The audio signal 106 can be expanded (e.g., zoomed in) to provide more detailed characteristics of the audio signal 106, as illustrated for example in FIG. 5A. Then, as illustrated in FIG. 5B, the decibel level 118 of the audio signal 106 can be produced. For example, in FIG. 5B, the decibel level 118 is at −4.2251 dB. This can be compared to the decibel level of other feet of the animal 10 to determine which foot is taking more load. For example, the foot taking more load can be the more sound limb and the foot taking less load can be the more lame limb.

The disclosure turns now to the video display 104, which is generated from a video signal (e.g., generated from a video file that includes the video signal) recorded of the animal 10 locomoting on the surface 12 (e.g., ground). The video display 104 can be used to correlate each audio portion 108 (e.g., 108a, 108b, 108c, 108d) to a footfall of a respective limb 14 (e.g., 14a, 14b, 14c, 14d) of the animal 10. In other words, the video display 104 can be used to determine which audio portion 108 corresponds to which footfall (e.g., limb 14 of the animal 10 impacting the surface 12). The video display may also be used to confirm system outputs, such as type of footfall, through visual inspection.

In various examples, the video is synchronized with the audio signal such that the timing of the video signal is aligned with the timing of the audio signal 106. So, for example, an audio portion for a given footfall is aligned with the video showing the same footfall. In some examples, as illustrated for example in FIG. 5B, when the video is played in the video display 104, the acoustic gait profile 102 includes a pointer 116 (e.g., time bar), which indicates a time-related location along the audio signal 106 that corresponds to the video in the video display 104. For example, the first audio portion 108a, which correspond to the footfall associated with the first limb 14a, can be correlated to the first limb 14a. The second audio portion 108b, which correspond to the footfall associated with the second limb 14b, can be correlated to the second limb 14b. The third audio portion 108c, which correspond to the footfall associated with the third limb 14c, can be correlated to the third limb 14c. The fourth audio portion 108d, which correspond to the footfall associated with the fourth 14d, can be correlated to the fourth limb 14d.

It should be noted that although the system 100 can include a video display 104 (e.g., to play video of the animal 10 as it moves along the surface 12) as illustrated for example in FIGS. 2-5B, a video display 104 is not required in the system 100. In the absence of a video display 104, various other methods are described herein correlated with an audio portion 108 with a footfall. As noted above, various real-time user interfaces may be used to identify a footfall. In another example, the system may include voice recognition that correlates some audible signal with the audio signal—e.g., a user simply says right front, etc., and the system encodes such indicators with the audio signal. Other correlation techniques are also possible.

In some embodiments, the video can be recorded by a video camera that is positioned to capture a path of travel of the animal 10 on the surface 12. In some examples, the video camera can be positioned approximately 15-feet from the path of travel of the animal 10 to record it as it walks past. The video camera can be connected to the receiver (e.g., an auxiliary cord). In one possible example, the animal 10 can be guided in both directions for approximately 50-feet. As the animal 10 is guided, the head of the animal 10 can be maintained in a straight position and the pace of the animal 10 can be evenly maintained. In some embodiments, the screen on the receiver may display a sliding bar to indicate if the pace of the animal 10 is too high. For example, the sliding bar can include a scale, such that the goal is “yellow” and the “red” indicates that the pace is too high. In the case of a horse, the goal is for the horse to walk at a pace where there are distinct footfalls.

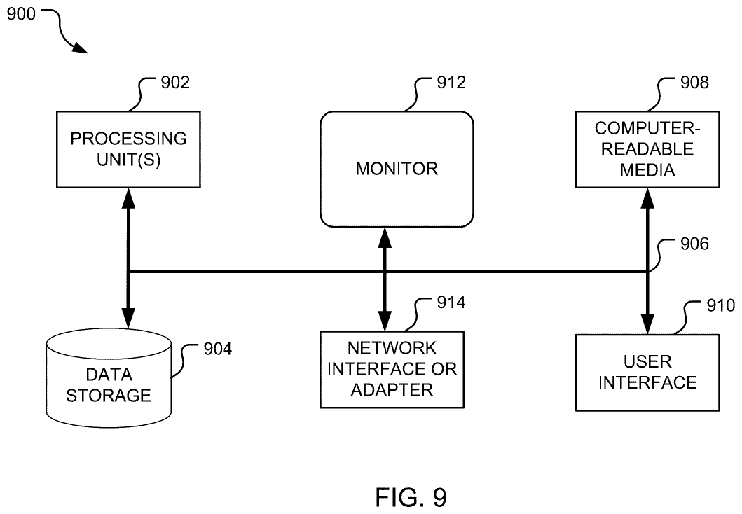

The recorded data (e.g., audio signal 106 recorded by the microphone 16, video recorded by the video camera) can be input into a computing device 600 (e.g., computer), as discussed below with respect to FIG. 9. The computing device 600 can include a digital audio editor (e.g., wavelab pro software). The audio signal 106 (e.g., from the microphone 16) can be received by the computing device 600 and opened with the digital audio editor, which can display the audio signal 106. In some embodiments, the video (e.g., from the video camera) can be received by the computer. In one example, a Secure Digital (SD) card can be removed from the video camera and plugged into a computer, and then the video can be saved to the computer. The digital audio editor can be opened, and the video can be imported. The video can be matched up to the audio signal 106, such that each footfall corresponds to each respective audio portion 108.

The audio signal 106 can be analyzed by assessing characteristics (e.g., peak, width, area, position) of the audio signal 106. For example, as discussed above, one or more characteristics of a first audio portion 108a can be compared to one or more characteristics of a second audio portion 108b.

While the system may be used to detect abnormal gaits, identify a limb or limbs, or combinations of limbs, associated with an abnormal gait (or simply issues with a limb or limbs distinct from the effect on gait), the system may also identify pathologic free gaits of a mammal—quadruped or biped—distinctly or use such pathologic free gait baselines to detect, alone or in combination with other factors, gait anomalies. Generally speaking, in a pathologic free gait of a mammal, the distribution of load is equal between RF and LF and equal between RH and LH for a quadruped and equal between R and L for a biped. For a horse, the front limbs absorb more load than the rear limbs, which may be 60% in the front limbs and 40% in the rear limbs, with some variations in the ratio for any given horse. For quadruped stride length, it is equal between RF and RH and LF and LH.

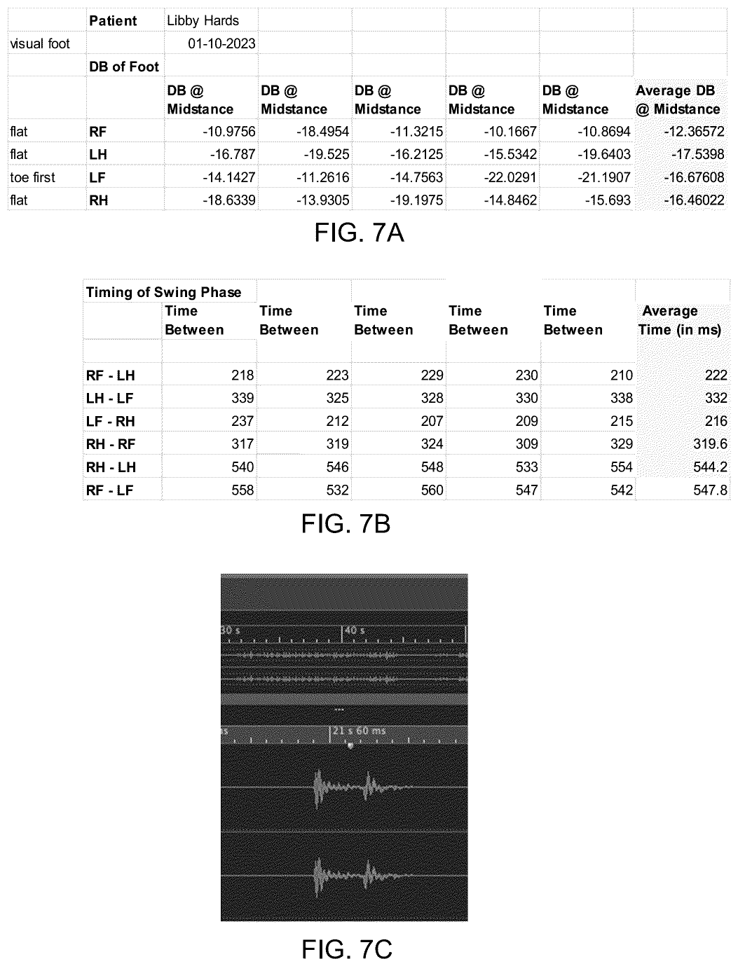

FIGS. 7A-7C shows amplitude and timing data of the four limbs of a first horse, and acoustical signals of footfalls. FIG. 7A is table showing five columns of decibel (amplitude) values for a midstance portion of signals of the right front (RF), left front (LH), left front (LF), and right hind (RH) of the four limbs of a horse. Referring to FIG. 7C, is a portion of an acoustical signal recording for the LF foot. Here, the signal portion includes two peaks with a portion of a lower decibel level between the two peaks. The midstance decibel level recorded for the LF footfall may be the second peak, or an average of the two peaks, or some other measure so long as the measure technique is consistent among the footfalls in terms of measuring a comparable value for each footfall. For a toe first landing as shown in FIG. 7C, there are two peaks with the initial leading peak being larger than the second peak. As noted elsewhere herein, the system may automatically identify a toe first landing from the two peak waveform. For the data in FIG. 7A, the decibel level in the midstance was collected for each leg and for five footfalls of each leg. The data also includes an average, for each limb, of the midstance decibel levels.

Referring to the averages, the average midstance decibel level of the right front leg is at −12, whereas the decibel levels of the LH, LF, and RH are −17, −16, and −16 respectively. As noted above, for a pathologic free gait, the RF and LF would land without about the same force. Here, however, there is about a 4-decibel difference between the RF and LF, which is about a 25% difference, and there is about a 4 to 5 decibel difference between the RF leg and the other legs, or it could be considered that the LH, LF and RH are about the same (within 1 decibel of each other). From this information, the RF footfall is landing meaningfully more forceful than the other legs. Similarly, the LF footfall is meaningfully softer than the RF footfall.

The system may compare these values in any possible arrangement. In one example, the decibel levels of the RF and LF are compared, and the decibel levels of the RH and LH are compared. The system may further compare front to rear decibel levels. The system may identify any differences, along with amplitudes of such differences, and the use the same in further analysis. The system may also, as noted herein, analyze the waveform portions for each footfall and quantify the type of footfall. The system may also generate a report, such as shown in FIG. 7A, and further highlight any differences.

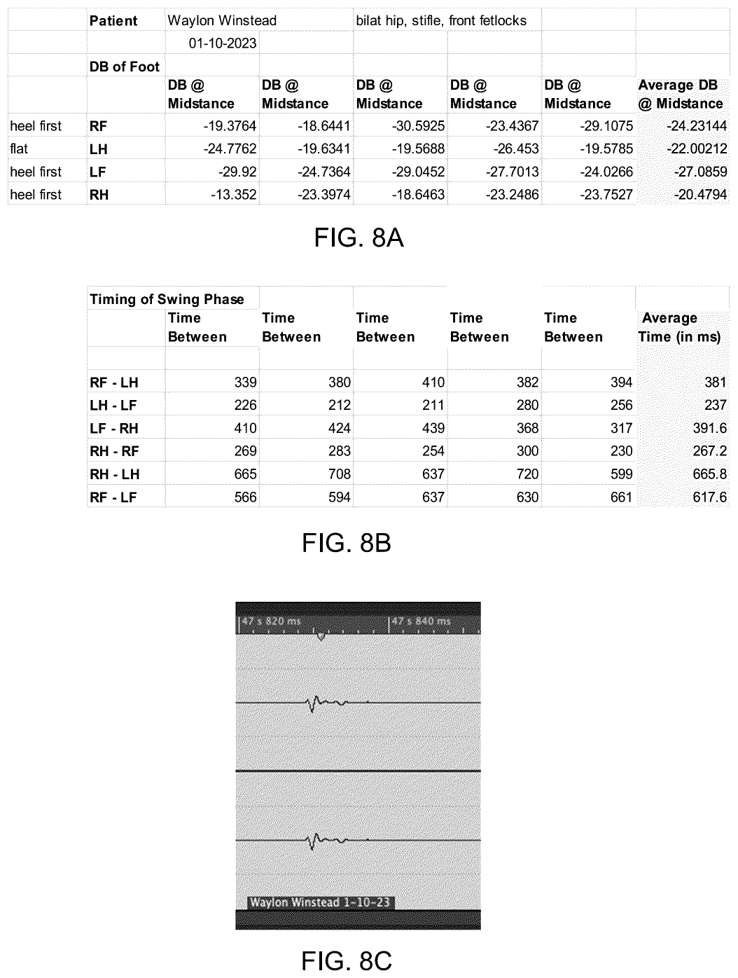

From visual data, such as a synchronized video of the horse walking when the audio signals were recorded, it is possible to confirm that the horse is landing toe first with the left front leg, and the other footfalls are all landing flat. While for a different horse, the signal in FIG. 8C is for a flat-footed landing, and it can be seen there are not two peaks. Instead, there is a single peak. The other footfalls for the data collected in FIG. 7 were similarly flat footed or otherwise normal. As with a toe strike comparative signal or signals, flat footed, heel strike and other comparative signals may also be used for comparison. These examples refer to a horse, but comparative signals may be stored and used for humans and other mammals.

In addition to identifying load differences between given limbs, and/or between different portions for a limb (e.g., toe, midstance, lift off) and characterizing the type of footfall (e.g., toe strike, flat footed, etc.), the system may also use stride information, alone in or in combination with these other characteristics. FIG. 7B is stride data for the same horse of FIGS. 76A and 7C. Here, there are five data values (time) collected for each of the timing of the swing phase (stride) for RF-LH, LH-LF, LF-RH, RH-RF, RH-LH, and RF-LF. The stride data also includes averages for each swing phase. The system may generate and display stride data, and the system may include various possible combinations of stride data for further assessment, alone or in combination, with other gait characteristics discussed herein.

FIGS. 8A-8C shows amplitude and timing data of the four limbs of a second horse, and acoustical signals of footfalls. FIG. 7A is table showing five columns of decibel (amplitude) values for a midstance portion of signals of the right front (RF), left front (LH), left front (LF), and right hind (RH) of the four limbs of a horse. Referring to FIG. 7C, the two signals are for the left hind. Here, the signal portions shown in FIG. 8C are quite distinct from the signals in FIG. 7C. In FIG. 7C, the first horse, in its left front hoof, was landing toe first resulting in a signal with two peaks. In contrast, the signal in FIG. 8C, for the left hind foot of the second horse, has one peak area. This is because the horse was landing flat footed. In a flat foot landing, there is one peak without any additional pronounced signal portions.

The signal differences illustrate additional aspects of the present disclosure. Namely, the system can identify signal traits and identify various gait characteristics from the same, such as a type of footfall. Here, for example, the system can compare a given portion of a signal against a collection of baseline signals and characterize the type of footfall that generated the portion of the signal. So, there may be a baseline signal including two peaks separated by a relatively lower decibel portion, which when compared against the waveform shown in FIG. 7C, would cause the system to characterize the footfall as toe first. Similarly, with regard to a baseline signal of one peak, when comparing the signal in FIG. 8C against the baseline, the system would characterize the footfall as flat footed. Other baselines may be generated for other forms of footfalls, including those of horses, other animals, and humans. Besides comparison, the system may identify attributes of an audio signal, such as the number of peaks and relative amplitude of the same, in other ways to generate a gait characteristic from the audio waveforms.

It should be noted that besides generic or general baseline signals, the system may also collect baseline signals for a patient over a period of time, including times when the patient is considered fully healthy. In the case of humans, for example, a person may naturally walk or run with different stride patterns—e.g., toe first or heal first, and with different lift of patterns. As such, it may be useful to identify differences in footfalls generically, e.g., a patient is landing with more force on one foot as compared to the other, but also may be useful, alone or in combination, to identify differences in stride patterns as compared to a baseline. Similarly, it may be useful to compare against a baseline in different scenarios such as walking, running, and sprinting. As such, general baseline signals in different scenarios—walking, running, sprinting, etc.—may be collected for a patient or generically for a collection of subjects for later comparison to the patient, with those baseline signals being associated with a fully healthy patient or a patient with known ailments or restrictions that may affect their gate.

Returning to the data depicted in FIG. 8A, the decibel level in the midstance was collected for each leg and for five footfalls of each leg. In one example, the midstance or more generally any comparative part of a signal may be manually identified through a user interface. For example, referring back to FIG. 7, a user may identify a part of the signal where the decibel level will be obtained—e.g., at a peak, an average of peaks, or some other part of the signal. In another example, the system may segment each portion of a signal into one or more discrete areas where a amplitude (e.g., decibel level) is obtained. For example, a portion of a signal for a footfall may have a width, and the signal be divided into a first portion related to the beginning part of the signal portion (e.g., where the initial peak is shown in FIG. 7C), a second or middle portion between the beginning and end of the signal portion, and a third or end portion. In one example, the signal portion may be divided in thirds. So, referring again to FIG. 7C, if the signal portions shown are roughly 50 ms wide, three time-windows of 16.6 ms may be generated, and the system may obtain a decibel level for each window. Similarly, in FIG. 8C, the signal portion may similarly be divided in thirds. If the signal portion here is also 50 ms, the initial peak area will be captured in the first window, the lower decibel area following the initial peak, e.g., the midstance, will be capture in the second window, and the third window will capture a value similar to the midstance level. A signal with two peaks may also be divided in a way that will allow the system to isolate and measure each peak.

The decibel level for each window may be a max level, an average level, etc. It is also possible for the system to initially define such windows and a user, through a GUI, adjust the boundaries of any given window and how the decibel level is obtained for each window. The start and end of a signal portion may be manually designated or automatically designated. When automatically designating, the system may compare decibel levels with a zero baseline and define a signal portion—a discrete footfall—based on when the decibel level rises above the zero baseline, which may include some threshold to avoid noise and false positives, and then falls back to zero, which may similarly include thresholds.

Returning again to the discussion of FIG. 8A, the data also includes an average, for each limb, of the midstance decibel levels. As noted above, the system characterized the signal for the left hind footfall as flat footed. While not shown, the signals for each of the other three footfalls were characterized as heel first signals. Besides a difference between the RF and LF levels indicating the horse is loading the RF leg more than the RL leg, the horse is also carrying more load in the hind as compared to the front, which is abnormal.

The stride data of FIG. 8B also shows a variety of differences. Most notably, the LH-LF timing is 237 ms as compared to the RH-RF of 267 ms, and the RH-LH stride is 665 ms and the RF-LF is 617 ms, all showing stride asymmetries and abnormalities.

FIG. 9 is a block diagram illustrating an example of a computing system for implementing certain aspects described herein. In other words, the following is a description of an exemplary computer 900 that is part of or useable with the assessment system 100 described herein. As illustrated, the computing and networking environment 900 includes a general purpose computing device 900, although it is contemplated that the networking environment 900 may include other computing systems, such as smart phones, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 900 may include various hardware components, such as a processing unit 902, a data storage 904 (e.g., a system memory), and a system bus 906 that couples various system components of the computer 900 to the processing unit 902. The system bus 906 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 900 may further include a variety of computer-readable media 908 that includes removable/non-removable media and volatile/nonvolatile media, but excludes transitory propagated signals. Computer-readable media 908 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 900. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 904 includes computer storage media in the form of volatile/nonvolatile memory such as read only memory (ROM) and random access memory (RAM). A basic input/output system (BIOS), containing the basic routines that help to transfer information between elements within the computer 900 (e.g., during start-up) is typically stored in ROM. RAM typically contains data and/or program modules that are immediately accessible to and/or presently being operated on by processing unit 902. For example, in one embodiment, data storage 904 holds an operating system, application programs, and other program modules and program data.

Data storage 904 may also include other removable/non-removable, volatile/nonvolatile computer storage media. For example, data storage 904 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 9, provide storage of computer-readable instructions, data structures, program modules and other data for the computer 900.

A user may enter commands and information through a user interface 910 or other input devices such as a tablet, electronic digitizer, a microphone, keyboard, and/or pointing device, commonly referred to as mouse, trackball or touch pad. TOther input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 902 through a user interface 910 that is coupled to the system bus 906, but may be connected by other interface and bus structures, such as a parallel port, game port or a universal serial bus (USB). A monitor 912 or other type of display device is also connected to the system bus 906 via an interface, such as a video interface. The monitor 912 may also be integrated with a touch-screen panel or the like.

The computer 900 may operate in a networked or cloud-computing environment using logical connections of a network interface or adapter 914 to one or more remote devices, such as a remote computer. The remote computer may be a personal computer, a server, a router, a network PC, a peer device or other common network node, and typically includes many or all of the elements described above relative to the computer 900. The logical connections depicted in FIG. 9 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 900 may be connected to a public and/or private network through the network interface or adapter 914. In such embodiments, a modem or other means for establishing communications over the network is connected to the system bus 906 via the network interface or adapter 914 or other appropriate mechanism. A wireless networking component including an interface and antenna may be coupled through a suitable device such as an access point or peer computer to a network. In a networked environment, program modules depicted relative to the computer 900, or portions thereof, may be stored in the remote memory storage device.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

Reference to “embodiment”, “aspect,” or “example” means that a particular feature, structure, or characteristic described in connection with the embodiment is included in at least one embodiment of the disclosure. The appearances of these phrases in various places in the specification are not necessarily all referring to the same embodiment, nor are separate or alternative embodiments mutually exclusive of other embodiments. Moreover, various features are described which may be exhibited by some embodiments and not by others.

It will be appreciated that for simplicity and clarity of illustration, where appropriate, reference numerals have been repeated among the different figures to indicate corresponding or analogous elements. In addition, numerous specific details have been set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. As such, elements of one system can be incorporated into any of the systems described herein. And, elements can be subtracted from any of the systems described herein without limitation.

What is claimed is:

1. An acoustic gait assessment method comprising:
with a computing device, accessing a first audio portion of an acoustic waveform of a ground surface impact of a first limb of a mammal;
comparing the first audio portion with a second audio portion; and
based on the comparison, identifying at least one difference between the first audio portion and the second audio portion.

2. The method of claim 1, wherein the second audio portion is of a ground impact of a second limb of the mammal.

3. The method of claim 2, wherein the acoustic waveform is obtained from a single microphone and the acoustic waveform further includes the second audio portion, and further wherein the first audio portion and the second audio portion are each associated with the respective first limb and the second limb.

4. The method of claim 1, wherein the second audio portion is of a ground surface impact of the first limb of the mammal taking later in time from the first audio portion.

5. The method of claim 4, wherein the acoustic waveform including the first audio portion is taken prior to at least one of a training, physical therapy, pharmacologic or surgical intervention of the mammal and the second audio portion is after the at least one of the training, physical therapy, pharmacologic or surgical intervention of the mammal.

6. The method of claim 1, wherein the at least one difference between the first audio portion and the second portion is an amplitude difference.

7. The method of claim 6, wherein the amplitude difference is based on a first peak in the first audio portion and a second peak in the second audio portion.

8. The method of claim 2, further comprising accessing a third audio portion corresponding to a third foot of the mammal impacting the surface and a fourth audio portion corresponding to a fourth foot of the mammal impacting the surface;
further comparing the third audio portion with the fourth audio portion; and
based on the comparisons, identifying a stride timing difference between at least one of the first portion, the second audio portion, the third audio portion and the fourth audio portion.

9. The method of claim 1, wherein the second audio portion is of a footfall associated with a second limb of the animal opposing the first limb of the mammal, wherein the at least one difference indicates the first audio portion is of lesser amplitude than the second audio portion indicating the first limb is being favored by the mammal.

10. The method of claim 1, further comprising a third audio portion of a footfall associated with a third limb of the mammal and a fourth audio portion of a footfall associated with a fourth limb of the mammal, wherein the first limb and the second limb are either a left front leg and a right front leg or a left rear leg and a right rear leg.

11. The method of claim 1, further comprising:
generating a display of the first audio portion and the second audio portion, the at least one difference represented in an amplitude difference of the first audio portion and the second audio signal portion.

12. The method of claim 1, wherein the at least one difference is a difference of a shape, width, or area of the first audio portion compared to a shape, width, or area of the second audio portion, wherein the first audio portion and the second audio portion are obtained from a microphone.

13. The method of claim 1, wherein the first audio signal includes a first peak amplitude and the second audio signal includes a second peak amplitude, wherein the at least one difference is represented by a difference of the first peak amplitude compared to the second peak amplitude, wherein the first peak amplitude being greater than the second peak value indicates that the mammal loads the first limb more than the second limb, wherein the second peak amplitude being greater than the first peak amplitude indicates that the mammal loads the second limb more than the first limb.

14. The method of claim 1, wherein a video signal is synchronized with the first audio portion and the second audio portion, the method further comprising displaying the video signal including a visual depiction of the footfall associated with the first limb of the mammal and of the footfall associated with the second limb of the mammal, wherein the visual depiction of the footfall associated with the first limb of the mammal is correlated to the first audio signal portion, wherein the visual depiction of the footfall associated with the second limb of the mammal is correlated to the second audio signal portion.

15. The method of claim 1, wherein the first audio portion is received from a microphone attached to the mammal.

16. The method of claim 16, wherein the mammal is a horse and wherein the microphone is attached to a ventral portion of a surcingle that is attached to the horse.

17. A method comprising:
at a computing device, accessing a first acoustical waveform from a microphone, the acoustical waveform including an audio portion of a footfall of a mammal; and
identifying a gait characteristic of the mammal from the audio portion of the first footfall of the mammal, wherein the gait characteristic is based on at least one of an amplitude, a timing, a shape, a width, or an area of the audio portion of the first acoustical waveform.

18. The method of claim 17 further comprising identifying at least one peak in the audio portion of the first acoustical waveform, and from the at least one peak, identifying the gait characteristic as toe first, flat footed or heal first.

19. The method of claim 17 further comprising accessing a second audio portion of a second footfall of the mammal, and identifying the gait characteristic of the mammal from a comparison of the audio portion of the footfall with the second audio portion of the second footfall, and wherein the audio portion is of a footfall of a first limb of the mammal and the second audio portion is of a footfall of a second limb of the mammal or the audio portion is of a footfall of a first limb of the mammal and second audio portion is of a footfall of the first limb of the mammal later in time from the first audio portion.

20. A system for assessing a gait characteristic of a mammal using acoustic information, the apparatus comprising:
a microphone positioned to obtain an acoustic waveform of the mammal locomoting on a surface; and
a computing device configured to process the acoustic waveform, the computing device including computer executable instructions configured to:
analyze at least one signal attribute of a first audio portion of the acoustic waveform of a ground surface impact of a first limb of the mammal locomoting on the surface;
comparing the at least one signal attribute of the first audio portion with a corresponding attribute of a second audio portion; and
based on the comparison, identifying at least one difference between the at least one attribute of first audio portion and the corresponding attribute of the second audio portion.
